(19) United States
(12) Patent Application Publication
(10) Pub. No.: US 2008/0277483 A1
(43) Pub. Date: Nov. 13, 2008

(54) Contactless IC card system with partible antenna

(75) Inventor: Chun-Hsin Ho, Taipei (TW)

Correspondence Address: BACON & THOMAS, PLLC, 625 SLATERS LANE, FOURTH FLOOR, ALEXANDRIA, VA, 22314-1176, US

(73) Assignee: Taisys Technologies Co., Ltd., Taipei (TW)

(21) Appl. No.: 11/798,211

(22) Filed: May 11, 2007

(51) Int. Cl. G06K 19/077

(52) U.S. Cl. 235/492

(57) ABSTRACT

An antenna apparatus for a contactless IC card system with an IC card is disclosed. The antenna apparatus includes a connecting unit having a first connecting wire disposed on one surface thereof and a second connecting wire disposed on the other surface thereof, both of which are connected to the IC card and covered by an isolating layer and have portions exposed to form a first attaching part and a second attaching part respectively on an attaching end of the connecting unit; and an antenna having an opening, a first conductive pad disposed on a first surface around the opening, and a second conductive pad disposed on a second surface, opposite to the first surface, around the opening. The attaching end of the connecting unit nestles the antenna and passes through the opening of the antenna to cause the first attaching part and the second attaching part to contact with the first conductive pad and the second conductive pad respectively, thereby adjusting a length of conductive circuits between the antenna and the IC card.

### FIELD OF THE INVENTION

The present invention relates to a contactless IC card system, and more particularly, to a contactless IC card system with a partible antenna.

### BACKGROUND OF THE INVENTION

Magnetic prepaid cards, widely available in the market, are highly convenient for users in that they can be used anonymously for an indefinite term by unspecified number of persons. However, the magnetic prepaid cards are always accompanied by a risk of unauthorized rewriting of data such as amount information and have a security weakness. Thus, in recent years, for the purpose of increasing security, such a magnetic card is replaced by an IC card. Accordingly, various IC cards are introduced to meet extensive consumer demands in hope of bringing a quicker, more convenient and secured consuming environment for consumers. The IC cards have a size approximately equal to that of a business card, which is easy to carry and it also includes a microchip for storing several tens of bytes to several tens of kilobytes of data. The IC cards have the functions of storing data and even executing application programs, and thus the IC cards are extensively used in many areas including identity cards, credit cards, electronic money, consumer bonus point cards, door security card, digital authentication cards, health insurance cards and telephone cards, etc. In general, an IC card is much more secured than a traditional magnetic card.

In recent years, contactless IC card and mobile phone become indispensable in our daily life. Therefore, finding a way of integrating the contactless IC card and the mobile phone to achieve the all-in-one function and effectively control consumer information, enhance data transmission rate and locate lost phones demands immediate attentions. As described in U.S. Pat. No. 6,973,327, it discloses an IC chip with IC card functions, a contactless IC card antenna, and an antenna connection circuit for connecting the IC chip and the contactless IC card antenna are provided on a mount board, and are combined to form a communication module, thereby making the communication module smaller. The communication module can be mounted on and removed from a mobile phone, thereby making it possible to downsize the mobile phone. Also, because the IC card antenna projects from a rear surface of a chassis of the mobile phone, the distance between the IC card antenna and the LCD panel or the ear receiver can be extended by the amount by which the contactless IC card antenna projects from the rear surface of the chassis, and thus the thickness of the chassis of the mobile phone can be reduced. However, one of the problems encountered in daily use of such a variety of cards lies in that one of the cards might not be available when it is to be used, no matter whether it is left at home, its credit has been run out, or it has expired. In addition, administration and carry of various cards is inconvenient. Therefore, a contactless IC module and a mobile phone system tend to be integrated into a unity.

In general, an integrated card system with contactless IC module should include an antenna for transmitting data. One of related arts is disclosed, e.g., in JP-A-11-149536. There is a description in this Publication saying the effect that “a composite IC card, which includes an IC module with an IC mounted therein and having both contact and non-contact type communication functions and an antenna for non-contact transmission, and wherein coils for signal transmission in the IC module and non-contact transmission antenna are arranged to be closely coupled to each other, that is, the IC module and non-contact transmission antenna are coupled by transformer coupling and are coupled in a non-contacted manner”. Another description says therein the effect that “the antenna coil coupled to an external read/write device in a non-contact state is arranged so as not to overlap an engagement portion for the IC module, which is an external terminal region serving as a contact type electrode, an embossing region, or a magnetic stripe region.”

Another one of related arts is disclosed in JP-A-2001-5920. This Publication states as follows in the effect. That is, a portable telephone is provided with an interface capable of data communication with a non-contact IC card, a reader/writer is provided with a function of calling the telephone and a function of performing two-way communication with the telephone, and the card and the telephone are arranged adjacent to each other. The reader/writer outputs a transmission signal for calling the telephone all time, the telephone establishes a two-way communication state with the reader/writer in response to the reception of the transmission signal, the telephone also transmits a request signal for requesting communication to the card in response to the reception of the transmission signal, and consequently, a two-way communication state is established between the telephone and the card.

The other one of related arts is disclosed in U.S. Pat. No. 6,840,448. As shown in FIG. 1A, it illustrates a portable telephone terminal 1 when viewed from its rear side, wherein an antenna bar 11 is used for transmitting and receiving electromagnetic waves in the portable telephone 12. A battery pack 2, a coil 3, an IC card module 4 are covered with an independent battery lid casing separated from the main body case 12 and cannot be viewed when the portable telephone terminal 1 is actually used. That is, FIG. 1A illustrates the portable telephone terminal with the battery lid casing removed. A constituent element not viewed directly even when the portable telephone terminal is illustrated with the battery lid casing removed is shown by a dotted line. When the portable telephone terminal 1 is viewed from its front, in many cases, a keypad is located on a front side opposed to the battery pack 2, and such a display as mentioned is located on the front side opposed to the main body case 12. There are two types of portable telephone terminals, one is a straight type which is kept to have such a shape as in FIG. 1A, and the other is a flipper type which is folded into two, when the keypad and display are accommodated. In this case, the IC card module is mounted by a suitable mounting means provided in the portable telephone. For example, the mounting means is to provide an insert port for insertion of the IC card module in the portable telephone. When the display is designed so as to display not only information relating to telephone but also information stored in the IC card module 4, e.g., the expiration date of train pass, pass section, or a mark indicative of normal operation of the IC card module 4, the portable telephone terminal can advantageously increase its use convenience.

FIG. 1B schematically shows relative positions of the battery pack 2, coil 3 and IC card module 4 in their height direction. FIG. 1B corresponds to FIG. 1A but when viewed from its lower side. In the drawing, a broken line indicates an interior partitioned by a plastic material or the like. The IC card module 4 is mounted in the form of being inserted in a recess made in the partitioned interior. The insertion and withdrawal of the IC card module 4 are carried out under a condition that the battery pack 2 was removed, but such insertion or withdrawal is not inconvenient because it is not often done. It is desirable that the coil 3 be generally larger than the IC card module 4 in area. In the illustrated example, the IC card module 4 is disposed so as to cover most part of the battery pack 2, but the present invention is not limited to such a disposal. The IC card module 4 may be disposed so as to cover the entire of the battery pack 2 or so as to spread into the interior of the main body case 12. The battery pack 2 may sometimes be formed integrally with a casing (not shown). In this case, it is considered upon the integral formation to dispose the coil 3 between the battery pack 2 and the casing or to form the coil 3 outside of the casing.

Furthermore, in FIGS. 2A and 2B, the IC card module 4 is positioned in the deep side of the battery pack 2. Even in such a case, the coil 3 can function when the portable telephone terminal is of such a straight type as shown in FIG. 1B. However, it is desirable that the coil 3 be formed rather with use of such a flexible substrate as shown in FIG. 2B, so that the coil can be extended as far as the deep side of the battery pack 2 and can be coupled sufficiently to the IC card module 4. The coil 3 may be located between the battery pack 2 and IC card module 4. In this case, it is also possible to form the coil 3 on the casing of the battery pack 2. The coil 3 may also be provided to be extended around other sides in the drawing. In FIGS. 2A and 2B, since the coil 3 is extended along the both surfaces of the battery pack 2, this is convenient from the viewpoint that the coil 3 can exchange information with an external RW (reader/writer) even from any of the front and rear surfaces of the portable telephone terminal 1. To this end, a part of the coil 3 corresponding to a lower side of the battery pack 2 in FIG. 2B is preferably extended further toward its left side to obtain nearly the same sensitivity for the both surfaces.

It should be noted that the antenna for the contactless IC card is different from the antenna of the portable communication device. It is a low power transmission antenna for contactless or Near Field Communication (NFC). Contactless transaction provides advantages over contact-type cards, such as faster transaction speed and ease of use. The transfer or reading of information for contactless transaction via the contactless is achieved by sending RF signals through the antenna extending from the contactless IC card. The user simply brings the contactless IC card with the function of contactless transaction close to a card reader within a range; the reader is enabled to read the identification data contained in the IC via the antenna. When a contactless transaction is used in a transportation system, the IC mounted in the card contains the user's account information or billing information. During the operation, the user may access or update the user's account. The contactless IC card may be detachably from the holder of the portable device as known in the art, and may be formed of a plastic material and be combined as a standard size of SIM card to insert into a cardholder of a mobile phone. In practice, the external antenna is always folded and covers a battery of mobile phone. However, the form of antenna should be in accordance with that of the contactless IC card.

Additionally, the related direction and position between the contactless IC card and the antenna are variable. Certainly, the contactless IC card could be disposed into a mobile phone in different directions and positions dependent on the design of the mobile phone. There could be several related combinations of a contactless IC card and an antenna. Meanwhile, the connection between the contactless IC card and the antenna is conducted via extending wires of antenna, wherein the contactless IC card and the antenna should be disposed in a relative direction and position. Therefore, some contactless IC card systems could not be introduced into some mobile phones due to the limitation of the disposing layout. FIGS. 3A-3C illustrate three relative situations between the contactless IC card 21 and the antenna 22, wherein the contactless IC card 21 and the antenna 22 are conducted via extending wires 221 of antenna 22. Obviously, the extending wires 221 in FIGS. 3A-3C are different in length and extended in different way. If a contactless IC card vendor provides the antenna with the extending wire in one specification, the contactless IC card system won't be introduced into all mobile phones. The contactless IC card is usually disposed in a fixed holder thereof, and then the external antenna might not be folded and covers a battery of mobile phone easily, because of the limitation of the disposing layout. Furthermore, each form of contactless IC card merely validates some specific form of antenna. Those antennas won't be suitable to dispose into all mobile phones, and more particularly, to a mobile phone of small size. It is inconvenient and will cost a lot to provide mobile phones in suitable size for contactless system.

Although some contactless IC cards with an antenna for a mobile phone are technically feasible, in practice they are very inconvenient to implement. Meanwhile, the prior art fails to introduce a contactless system with an antenna to be set into any mobile phone having a contactless IC card disposed in any direction easily. Therefore, it needs to provide a contactless IC card system with a partible antenna, which introduces a partible antenna for use with any mobile phone having a contactless card disposed in several directions for facilitating to be set up, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a contactless IC card system with a partible antenna, which introduces a partible antenna for use with any mobile phone having a contactless card disposed in several directions for facilitating to be setup without the limitation of relative positions between antenna and the IC card, and can rectify those drawbacks of the prior art and solve the above problems.

In accordance with an aspect of the present invention, an antenna apparatus for a contactless IC card system with an IC card is disclosed. The antenna apparatus at least includes a connecting unit having a first connecting wire disposed on one surface thereof and a second connecting wire disposed on the other surface thereof, both of which are connected to the IC card and covered by an isolating layer and have portions exposed to form a first attaching part and a second attaching part respectively on an attaching end of the connecting unit; and an antenna having an opening, a first conductive pad disposed on a first surface around the opening, and a second conductive pad disposed on a second surface, opposite to the first surface, around the opening, wherein the attaching end of the connecting unit nestles the antenna and passes through the opening of the antenna to cause the first attaching part and the second attaching part to contact with the first conductive pad and the second conductive pad respectively, thereby adjusting a length of conductive circuits between the antenna and the IC card.

Preferably, the contactless IC card is used for a transaction device including a mobile phone or a personal digital assistant.

Preferably, the antenna apparatus further includes a top passive layer and a bottom passive layer for covering the first surface and the second surface of the antenna, respectively.

Preferably, the first conductive pad and the second conductive pad further comprise electrically conductive adhesives for binding the first attaching part and the second attaching part respectively.

Preferably, the first attaching part and the second attaching part are porous or mesh-like.

Certainly, the antenna and the connecting unit can be flexible.

Certainly, the antenna is looped or wound around the opening.

Certainly, the first conductive pad is connected to the second conductive pad via a through-hole on the antenna.

Preferably, the antenna and the connecting unit are fixed by means of thermal pressing while the antenna and the connecting unit are orientated.

In accordance with an aspect of the present invention, a contactless IC card system for a transaction device is disclosed. The contactless IC card system includes an IC card having a connecting terminal; a connecting unit connected to the connecting terminal of the IC card and having a first connecting wire disposed on one surface thereof and a second connecting wire disposed on the other surface thereof, both of which extend from the connecting terminal of the IC card, are covered by an isolating layer and have portions exposed to form a first attaching part and a second attaching part respectively on an attaching end of the connecting unit; and an antenna having an opening, a first conductive pad disposed on a first surface around the opening, and a second conductive pad disposed on a second surface, opposite to the first surface, around the opening, wherein the attaching end of the connecting unit nestles the antenna and passes through the opening of the antenna to cause the first attaching part and the second attaching part to contact with the first conductive pad and the second conductive pad respectively, thereby adjusting a length of conductive circuits between the antenna and the IC card.

Certainly, the transaction device includes a mobile phone or a personal digital assistant.

Preferably, the antenna further includes a top passive layer and a bottom passive layer for covering the first surface and the second surface of the antenna, respectively.

Certainly, the first conductive pad is connected to the second conductive pad via a through-hole on the antenna.

Preferably, the first conductive pad and the second conductive pad further include electrically conductive adhesives for binding the first attaching part and the second attaching part respectively.

Preferably, the first attaching part and the second attaching part are porous or mesh-like.

Preferably, the antenna and the connecting unit are flexible.

Certainly, the antenna can be looped or wound around the opening.

Preferably, the antenna and the connecting unit are fixed by means of thermal pressing while the antenna and the connecting unit are orientated.

### BRIEF DESCRIPTION OF THE DRAWING

The above objects and advantages of the present invention will become more readily apparent to those ordinarily skilled in the art after reviewing the following detailed description and accompanying drawings, in which:

FIGS. 1A-1B illustrate an embodiment of a portable telephone terminal with an antenna bar according to the prior art;

FIGS. 2A-2B illustrate another embodiment of a portable telephone terminal with an antenna bar according to the prior art;

FIGS. 3A-3C illustrate three relative situations between a contactless IC card and an antenna according to the prior art;

FIGS. 4A-4C illustrate a first embodiment of an antenna apparatus for a contactless IC card system according to the present invention;

FIGS. 5A-5B illustrate an attaching end of connecting unit according to the present invention;

FIG. 6 illustrates a second embodiment of an antenna apparatus for a contactless IC card system according to the present invention.

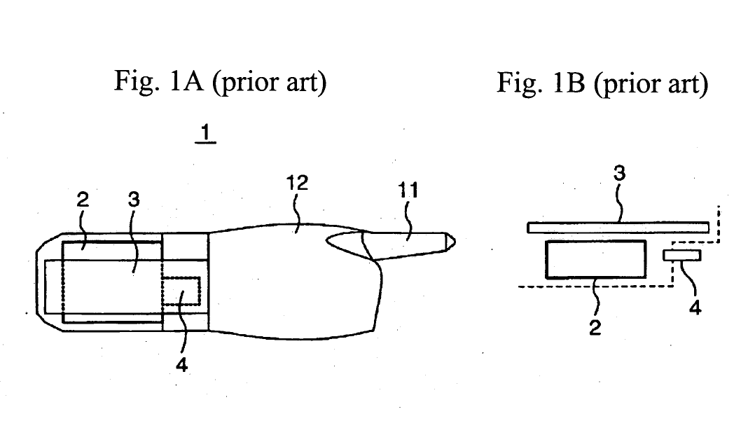

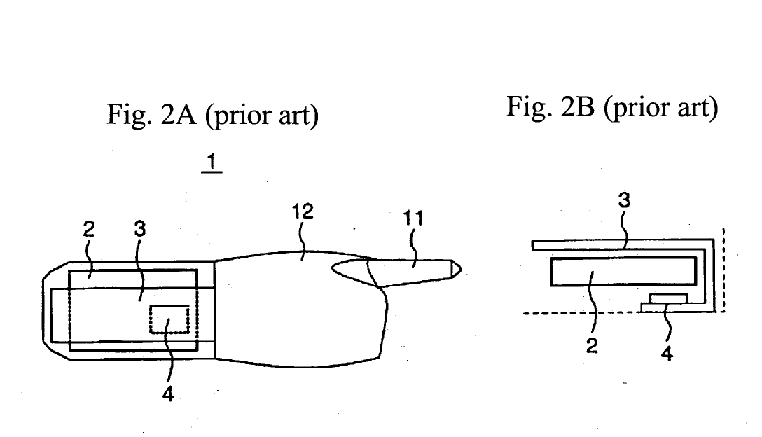

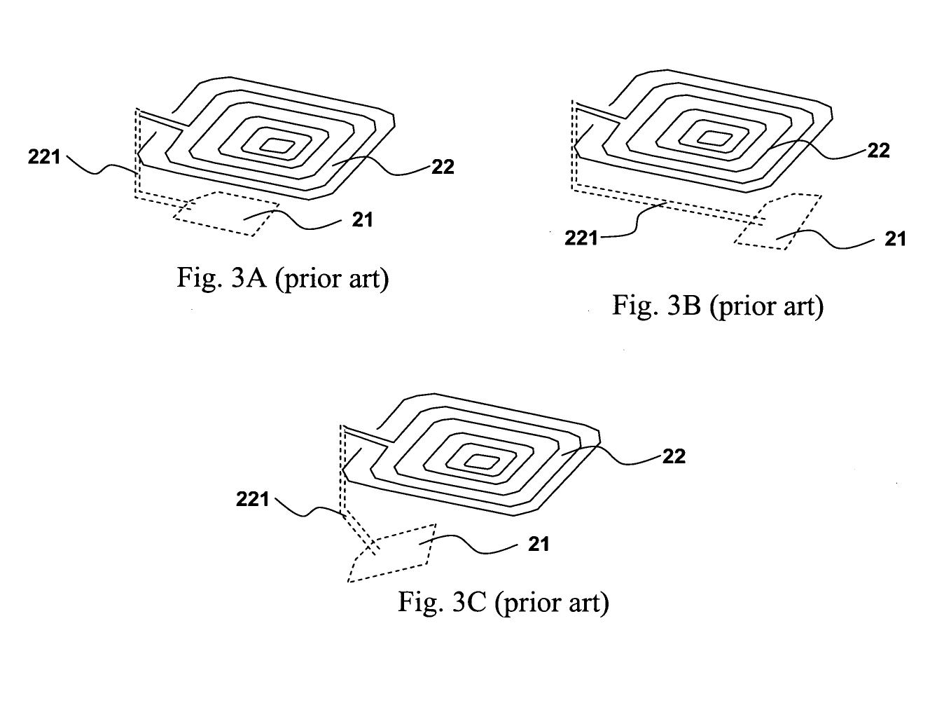

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

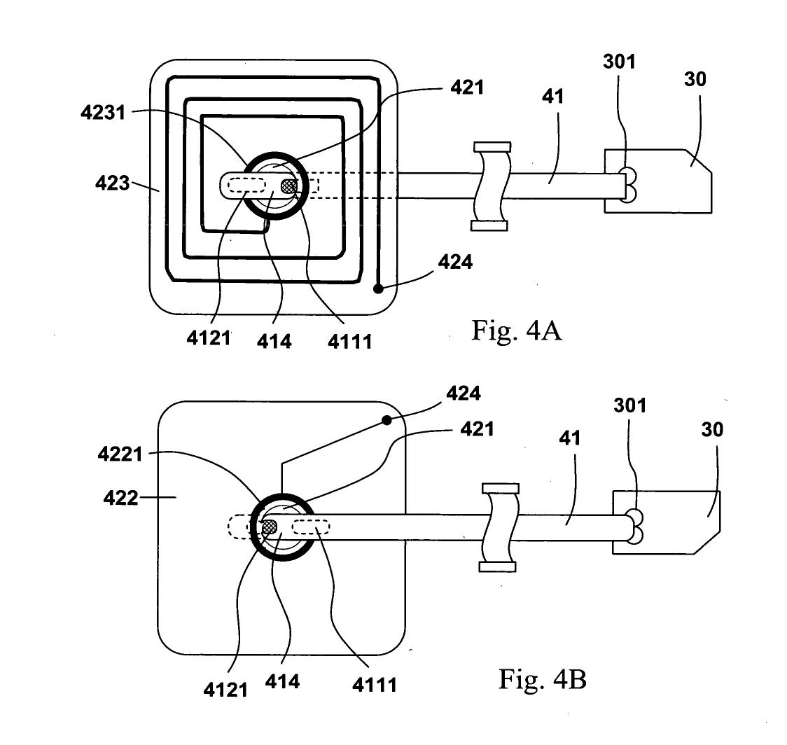

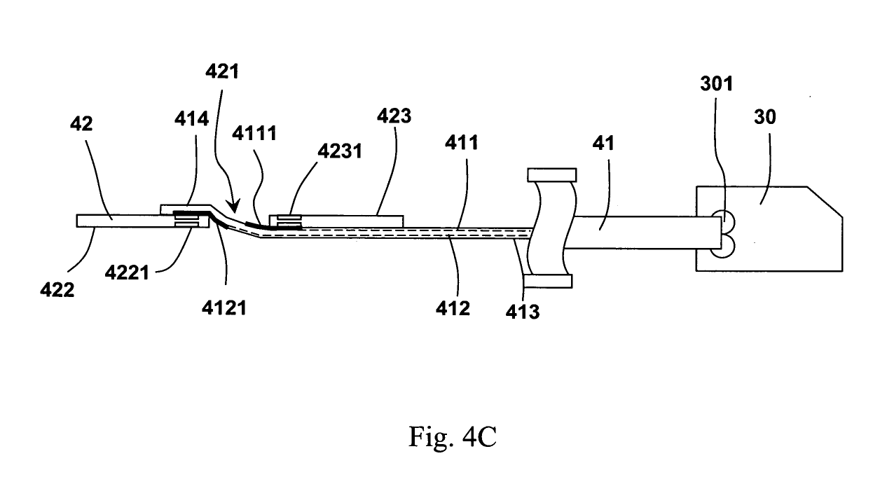

Please refer to FIGS. 4A, 4B, 4C. FIG. 4A illustrates a top view of a first embodiment of the antenna apparatus according to the present invention, FIG. 4B illustrates a bottom view of the first embodiment of the antenna apparatus according to the present invention, and FIG. 4C illustrates a cross-sectional view of the first embodiment of the antenna apparatus according to the present invention. As shown in FIGS. 4A-4C, the antenna apparatus includes a connecting unit 41 and an antenna 42. The connecting unit 41 has a first connecting wire 411 disposed on one surface thereof and a second connecting wire 412 disposed on the other surface thereof, both of which are connected to the IC card 30 and covered by an isolating layer 413 and have portions exposed to form a first attaching part 4111 and a second attaching part 4121 respectively on an attaching end 414 of the connecting unit 41. The antenna 42 has an opening 421, a first conductive pad 4221 disposed on a first surface 422 around the opening 421, and a second conductive pad 4231 disposed on a second surface 423, opposite to the first surface, around the opening 421. The attaching end 414 of the connecting unit 41 nestles the antenna 42 and passes through the opening 421 of the antenna 42 to cause the first attaching part 4111 to contact with the second conductive pad 4231, and the second attaching part 4121 to contact with the first conductive pad 4221 respectively, thereby adjusting a length of conductive circuits between the antenna 42 and the IC card 30.

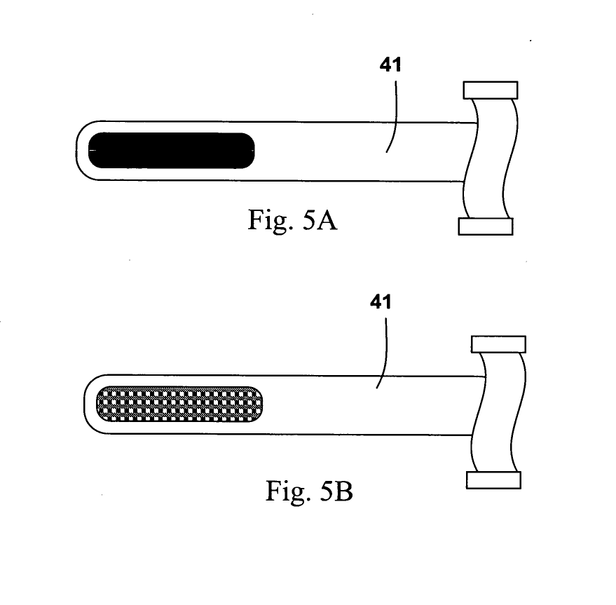

In practice, the contactless IC card 30 is used for a transaction device including a mobile phone or a personal digital assistant. Usually, the contactless IC card 30 is inserted and disposed into a SIM holder of a mobile phone or a personal digital assistant. When the contactless IC card 30 is inserted and disposed into the SIM holder, the connecting unit 41 of the present invention would have the first connecting wire 411 and the second connecting wire 412 electrically connected to the contactless IC card 30. Meanwhile, the contactless IC card 30 includes a connecting terminal 301 for electrically connecting with the first connecting wire 411 and the second connecting wire 412. In the present invention, although the first connecting wire 411 and the second connecting wire 412 are disposed on different surfaces, they could both connect to the connecting terminal 301 via any method as well known in art. The features of the first connecting wire 411 and the second connecting wire 412 are the structures of the first attaching part 4111 and the second attaching part 4121 thereof. The first attaching part 4111 and the second attaching part 4121 are porous or mesh-like by means of exposing portions of the first connecting wire 411 and the second connecting wire 412, as shown in FIGS. 5A and 5B. Moreover, the first conductive pad 4221 and the second conductive pad 4231 are made of copper for providing a good electric conductivity. Certainly, the first conductive pad 4221 and the second conductive pad 4231 could further include electrically conductive adhesives for binding the first attaching part 4111 and the second attaching part 4121, respectively. In this embodiment, the antenna 42 and the connecting unit 41 can be flexible for being folded according to the requirement of disposition. The antenna 42 of the present invention could be looped or wound around the opening 421. Since the first conductive pad 4221 is disposed on the first surface 422 around the opening 421, and the second conductive pad 4231 is disposed on the second surface 423, opposite to the first surface 422, around the opening 421, the first conductive pad 4221 is connected to the second conductive pad 4231 via a through-hole 424 on the antenna 42.

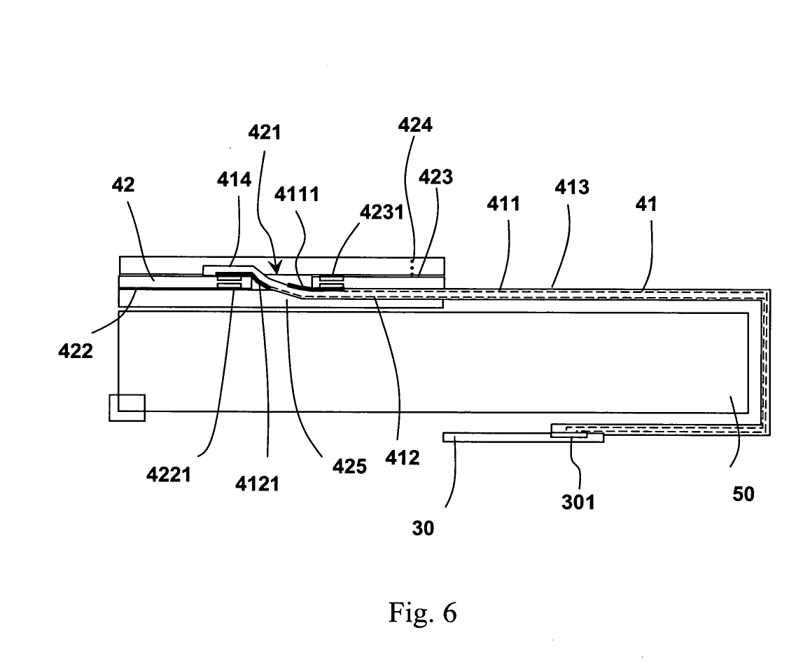

In accordance with another aspect, the present invention further provides a contactless IC card system for a transaction device. Referring to FIG. 6 and FIGS. 4A-4B, the contactless IC card system includes an IC card 30, a connecting unit 41, and an antenna 42. The IC card 30 has a connecting terminal 301. The connecting unit 41 is connected to the connecting terminal 301 of the IC card 30 and has a first connecting wire 411 disposed on one surface thereof and a second connecting wire 412 disposed on the other surface thereof, both of which extend from the connecting terminal 301 of the IC card 30, are covered by an isolating layer 413 and have portions exposed to form a first attaching part 4111 and a second attaching part 4121 respectively on an attaching end 414 of the connecting unit 41. The antenna 42 has an opening 421, a first conductive pad 4221 disposed on a first surface 422 around the opening 421, and a second conductive pad 4231 disposed on a second surface 423, opposite to the first surface 422, around the opening 421. The attaching end 414 of the connecting unit 41 nestles the antenna 42 and passes through the opening 421 of the antenna 42 to cause the first attaching part 4111 to contact with the second conductive pad 4231, and the second attaching part 4121 to contact with the first conductive pad 4221 respectively, thereby adjusting a length of conductive circuits between the antenna 42 and the IC card 30.

Similarly, the contactless IC card 30 is used for a transaction device including a mobile phone or a personal digital assistant. Usually, the contactless IC card 30 is inserted and disposed into a SIM holder of mobile phone or a personal digital assistant. When the contactless IC card 30 is inserted and disposed into the SIM holder, the connecting unit 41 of the present invention would have the first connecting wire 411 and the second connecting wire 412 electrically connected to the contactless IC card 30. Meanwhile, the contactless IC card 30 includes a connecting terminal 301 for electrically connecting with the first connecting wire 411 and the second connecting wire 412. Furthermore, the antenna 42 is always folded and covers a battery 50 of mobile phone or a personal digital assistant.

More particularly, the antenna 42 further includes a top passive layer 424 and a bottom passive layer 425 for covering the second surface 423 and the first surface 422 of the antenna 42, respectively. Accordingly, the antenna 42 and the attaching end 414 of the connecting unit 41 are fixed by means of thermal pressing while the antenna and the connecting unit are orientated. The first conductive pad 4221 and the second conductive pad 4231 are made of copper for providing a good electric conductivity. Certainly, the first conductive pad 4221 and the second conductive pad 4231 could further include electrically conductive adhesives for binding the first attaching part 4111 and the second attaching part 4121 respectively. In this embodiment, the antenna 42 and the connecting unit 41 can be flexible for being folded according to the requirement of disposition. The antenna 42 of the present invention could be looped or wound around the opening 421. Since the first conductive pad 4221 is disposed on the first surface 422 around the opening 421, and the second conductive pad 4231 is disposed on the second surface 423, opposite to the first surface 422, around the opening 421, the first conductive pad 4221 is connected to the second conductive pad 4231 via a through-hole 424 on the antenna 42.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An antenna apparatus for a contactless IC card system with an IC card, comprising:
a connecting unit having a first connecting wire disposed on one surface thereof and a second connecting wire disposed on the other surface thereof, both of which are connected to said IC card and covered by an isolating layer and have portions exposed to form a first attaching part and a second attaching part respectively on an attaching end of said connecting unit; and
an antenna having an opening, a first conductive pad disposed on a first surface around said opening, and a second conductive pad disposed on a second surface, opposite to said first surface, around said opening, wherein said attaching end of said connecting unit nestles said antenna and passes through said opening of said antenna to cause said first attaching part and said second attaching part to contact with said first conductive pad and said second conductive pad respectively, thereby adjusting a length of conductive circuits between said antenna and said IC card.

2. The antenna apparatus according to claim 1, wherein said contactless IC card is used for a transaction device comprising a mobile phone or a personal digital assistant.

3. The antenna apparatus according to claim 1, further comprising a top passive layer and a bottom passive layer for covering said first surface and said second surface of said antenna, respectively.

4. The antenna apparatus according to claim 1, wherein said first conductive pad and said second conductive pad further comprise electrically conductive adhesives for binding said first attaching part and said second attaching part, respectively.

5. The antenna apparatus according to claim 1, wherein said first attaching part and said second attaching part are porous or mesh-like.

6. The antenna apparatus according to claim 1, wherein said antenna and said connecting unit are flexible.

7. The antenna apparatus according to claim 1, wherein said antenna is looped or wound around said opening.

8. The antenna apparatus according to claim 1, wherein said first conductive pad is connected to said second conductive pad via a through-hole on said antenna.

9. The antenna apparatus according to claim 1, wherein said antenna and said connecting unit are fixed by means of thermal pressing while said antenna and said connecting unit are orientated.

10. A contactless IC card system for a transaction device, comprising:
an IC card having a connecting terminal;
a connecting unit connected to said connecting terminal of said IC card and having a first connecting wire disposed on one surface thereof and a second connecting wire disposed on the other surface thereof, both of which extend from said connecting terminal of said IC card, are covered by an isolating layer and have portions exposed to form a first attaching part and a second attaching part respectively on an attaching end of said connecting unit; and
an antenna having an opening, a first conductive pad disposed on a first surface around said opening, and a second conductive pad disposed on a second surface, opposite to said first surface, around said opening, wherein said attaching end of said connecting unit nestles said antenna and passes through said opening of said antenna to cause said first attaching part and said second attaching part to contact with said first conductive pad and said second conductive pad respectively, thereby adjusting a length of conductive circuits between said antenna and said IC card.

11. The contactless IC card system according to claim 10, wherein said transaction device comprises a mobile phone or a personal digital assistant.

12. The contactless IC card system according to claim 10, wherein said antenna further comprises a top passive layer and a bottom passive layer for covering said first surface and said second surface of said antenna, respectively.

13. The contactless IC card system according to claim 10, wherein said first conductive pad is connected to said second conductive pad via a through-hole on said antenna.

14. The contactless IC card system according to claim 10, wherein said first conductive pad and said second conductive pad further comprise electrically conductive adhesives for binding said first attaching part and said second attaching part, respectively.

15. The contactless IC card system according to claim 10, wherein said first attaching part and said second attaching part are porous or mesh-like.

16. The contactless IC card system according to claim 10, wherein said antenna and said connecting unit are flexible.

17. The contactless IC card system according to claim 10, wherein said antenna is looped or wound around said opening.

18. The contactless IC card system according to claim 10, wherein said antenna and said connecting unit are fixed by means of thermal pressing while said antenna and said connecting unit are orientated.
